(19) United States
(12) Patent Application Publication
(10) Pub. No.: US 2015/0035373 A1
(43) Pub. Date: Feb. 5, 2015

(54) SYSTEM OF WIRELESS POWER TRANSMISSION AND METHOD THEREOF

(71) Applicant: SIMPLO TECHNOLOGY CO., LTD., Hsinchu County (TW)

(72) Inventors: MING-DA CHEN, HSINCHU COUNTY (TW); YU-RU LIN, TAIPEI CITY (TW)

(73) Assignee: SIMPLO TECHNOLOGY CO., LTD., Hsinchu County (TW)

(21) Appl. No.: 14/135,531

(22) Filed: Dec. 19, 2013

(30) Foreign Application Priority Data
Aug. 2, 2013 (TW) 102127756

(51) Int. Cl. H04B 5/00

(52) U.S. Cl. CPC H04B 5/0037
USPC 307/104

(57) ABSTRACT

A management system of wireless power transmission comprises a plurality of first power modules, wherein the first power modules form a first cluster. Each of the first power modules comprises a first power unit, an energy information unit, a first wireless transceiver unit and a first control unit. The energy information unit is coupled to the first power unit. The first wireless transceiver unit is used for sending or receiving the first power transmission information and electrical energy. The first control unit is coupled to the energy information unit and the first wireless transceiver unit, and controls the first wireless transceiver unit to send or receive power transmission information and electrical energy. The first wireless transceiver units send the first power transmission information to each other. The first power modules determine the priority according to a control signal.

### BACKGROUND OF THE INVENTION

1. Field of the Invention

The instant disclosure relates to wireless power transmission; in particular, to a system of wireless power transmission for a plurality of power modules and a method thereof.

2. Description of Related Art

With the advancement of technology, people have increased requirements to mobile devices, such as the notebook, the tablet PC, the smart phone . . . etc. However, the mobile device utilizes the battery for power supply, and the mobile device needs to be wired to a charging device for charging the battery in the mobile device. Thus, the convenience of using the mobile device during charging status is limited accordingly. For improving the convenience of power charging, the technologies about wireless charging, such as inductive coupling or resonant inductive coupling, have been developed and matured.

At present, the wireless charging device could resolve the disadvantage of wired charging for mobile device. However, the present wireless charging technology utilizes a power module in the electronic device (which is a power receiving terminal) to couple with the power supply module of the power source for charging the power module in the electronic device. The power receiving terminal does not comprise any mechanism to determine whether to receive electrical energy from the power source automatically, and the power source also does not comprise any mechanism to determine whether to transmit electrical energy automatically.

As the effective wireless charging distance increased, the wireless charging technologies may not effectively used when using the effective charging distance of the power supply module as a basis of charging range.

Thus, this instant disclosure is for improving the wireless charging mechanism, in order to make full use of the effective charging distance of wireless charging. The wireless transmission mode of electric energy could be improved accordingly.

### SUMMARY OF THE INVENTION

The object of the instant disclosure is to offer a system of wireless power transmission and a method thereof, in which the plurality of power module with capability of wireless power transmission could be controlled to transmit electrical energy to each other.

In order to achieve the aforementioned objects, according to an embodiment of the instant disclosure, a system of wireless power transmission is provided. The system of wireless power transmission comprises a plurality of first power modules. The plurality of first power modules forms a first cluster. Each first power module comprises a first power unit, an energy information unit, a first wireless transceiver unit and a first control unit. The first power unit has a first electric energy. The energy information unit coupled to the first power unit is for generating a first power transmission information. The first power transmission information comprises at least one of the first electric energy, the distance of power transmission, an address of the communication protocol and a corresponding name of the first power module. The first wireless transceiver unit has at least a first wireless transmission terminal. The wireless transceiver unit sends/receives the first power transmission information and electrical energy through the first wireless transmission terminal. The first control unit is coupled to the energy information unit and the first wireless transceiver unit. The first control unit controls the first wireless transceiver unit to send/receive the first power transmission information and electrical energy. The first wireless transceiver units of the plurality of first power modules send the first power transmission information to each other. The first power modules determine the priority for each other according to a control signal.

In order to achieve the aforementioned objects, according to an embodiment of the instant disclosure, a system of wireless power transmission is provided. The system of wireless power transmission comprises at least a first power module and a second power module. The first power module forms a first cluster. The first power module comprises a first power unit, a first energy information unit, a first wireless transceiver unit and a first control unit. The first power unit has a first electric energy. The first energy information unit coupled to the first power unit is for generating a first power transmission information. The first wireless transceiver unit has at least a first wireless transmission terminal. The wireless transceiver unit sends/receives the first power transmission information and electrical energy through the first wireless transmission terminal. The first control unit is coupled to the first energy information unit and the first wireless transceiver unit. The first control unit controls the first wireless transceiver unit to send/receive the first power transmission information and electrical energy. The first power transmission information comprises at least one of the first electric energy, the distance of power transmission, an address of the communication protocol and a corresponding name of the first power module. The second power module comprises a second power unit, a second energy information unit, second control unit and a second wireless transceiver unit. The second power unit has a second electric energy. The second energy information unit coupled to the second power unit is for generating a second power transmission information. The second power transmission information comprises at least one of the second electric energy, the distance of power transmission, an address of the communication protocol and a corresponding name of the second power module. The second control unit is coupled to the first energy information unit. The second wireless transceiver unit coupled to the second control unit has at least a second wireless transmission terminal. The second wireless transceiver unit and the first wireless transceiver unit send/receive the first power transmission information and the second power transmission information to each other. The second wireless transceiver unit generates a control signal according to first power transmission information and the second power transmission information. The control signal is sent to the first power module through the second wireless transceiver unit. The first control unit of the first power module determines the priority for the first power module according to the control signal.

In order to achieve the aforementioned objects, according to an embodiment of the instant disclosure, a method of wireless power transmission is provided. The method comprises providing a plurality of first power modules to from a first cluster, the first power module having a first electric energy, the first power module comprising a first wireless transceiver unit and a first control unit, the first wireless transceiver unit wireless sending/receiving a first power transmission information and electrical energy, the first control unit of the first power module controlling the first wireless transceiver unit to send/receive the first power transmission information and electrical energy, wherein the first power transmission information comprises at least one of the first electric energy, the distance of power transmission, an address of the communication protocol and a corresponding name of the first power module. The plurality of power modules determines the priority of wireless sending/receiving electrical energy according to a control signal.

In summary, the system and method of wireless power transmission determine whether the plurality of power modules transmit electrical energy to each other, and determine the electrical energy should be transmitted to which one power module or which power modules. The system and method of wireless power transmission could determine whether the power module receives the electrical energy, and even determine the power module receive electrical energy from which one power module or which power modules. The power transmission information could be transmitted between the plurality of power modules.

In order to further the understanding regarding the instant disclosure, the following embodiments are provided along with illustrations to facilitate the disclosure of the instant disclosure.

### BRIEF DESCRIPTION OF THE DRAWINGS

FIG. 1 shows a schematic diagram of a system of wireless power transmission according to an embodiment of the instant disclosure;

FIG. 2A shows a block diagram of a power module in the system of wireless power transmission according to an embodiment of the instant disclosure;

FIG. 2B shows a block diagram of a power module in the system of wireless power transmission according to an embodiment of the instant disclosure;

FIG. 3 shows a schematic diagram of a system of wireless power transmission according to another embodiment of the instant disclosure;

FIG. 4 shows a schematic diagram of a system of wireless power transmission according to another embodiment of the instant disclosure;

FIG. 5A shows a schematic diagram of a system of wireless power transmission arranged in a star topology according to another embodiment of the instant disclosure;

FIG. 5B shows a schematic diagram of a system of wireless power transmission arranged in a linear topology according to another embodiment of the instant disclosure;

FIG. 5C shows a schematic diagram of a system of wireless power transmission arranged in a tree topology according to another embodiment of the instant disclosure;

FIG. 6 shows a flow chart of a method of wireless power transmission according to an embodiment of the instant disclosure; and

FIG. 7 shows a flow chart of a method of wireless power transmission according to another embodiment of the instant disclosure.

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

### An Embodiment for a System of Wireless Power Transmission

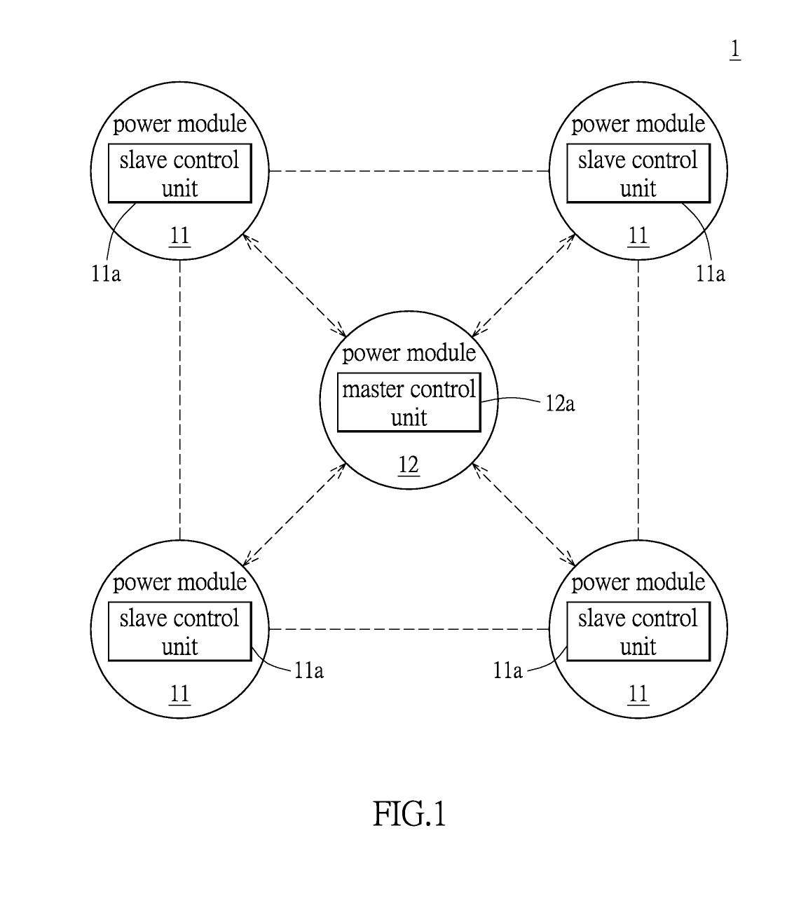

Please refer to FIG. 1 showing a schematic diagram of a system of wireless power transmission according to an embodiment of the instant disclosure. The system of wireless power transmission shown in FIG. 1 is for exemplary describing the concept of the instant disclosure, more detailed descriptions and components would be described hereinafter. The system of wireless power transmission 1 comprises four power modules 11 and a power module 12. The power modules 11 form (or establish) a first cluster. The instant disclosure does not restrict the classification manner for the power modules 11. The power modules 11 may be divided into the first power modules, the second power modules . . . , and the n-th power modules (not shown in the figure) to form the first cluster, the second cluster . . . , and the n-th cluster. The power module 12 and four power modules 11 could transmit electrical energy to each other. The transmitted electrical energy also includes energy information which is converted to electrical energy, and the energy information could be transmitted in the form of electrical energy. The energy information could be extracted from the transmitted electrical energy by the power modules (11, 12) when the power modules (11, 12) receive the electrical energy. The wireless charging technology includes five types as follows: capacitive coupling, microwave, electromagnetic coupling, magnetic induction and magnetic resonance. In wireless charging, the mentioned electrical energy may be the energy transmitted between the Rx (receiver) and Tx (transmitter) using the electromagnetic field (utilizing magnetic induction or magnetic resonance, for example). The power module 12 may be a power module with capability of wireless power transmission, a wireless charging transmitter, or a wireless charging desk disclosed in Taiwan Patent No. M381111, which is a device providing wireless charging function. This embodiment does not limit the number of the power modules 11.

In this embodiment, the system of wireless power transmission 1 comprises a plurality of power modules 11 and a power module 12. The plurality of power modules 11 and the power module 12 form a cluster. Each power module 11 comprises a first power unit 111, an energy information unit 112, a first wireless transceiver unit 114 and a first control unit 113. The configuration and functions of the power module 12 is identical to the power module 11, thus the power module 12 may be one of the power modules 11. The first power unit 11 has a first electric energy. The energy information unit 112 is coupled to the first power unit 111 for generating a first power transmission information. The first power transmission information comprises at least one of the first electric energy, the distance of power transmission, an address of the communication protocol and a corresponding name of the first power module 11. The first wireless transceiver unit 114 has at least a first wireless transmission terminal. The wireless transceiver unit 114 sends/receives the first power transmission information and electrical energy through the first wireless transmission terminal. The first control unit 113 is coupled to the energy information unit 112 and the first wireless transceiver unit 114, for controlling the first wireless transceiver unit 114 to send/receive the first power transmission information and electrical energy. The first wireless transceiver units 114 of the plurality of first power modules 11 send the first power transmission information to each other. The plurality of first power modules 11 determines the priority for each other according to a control signal.

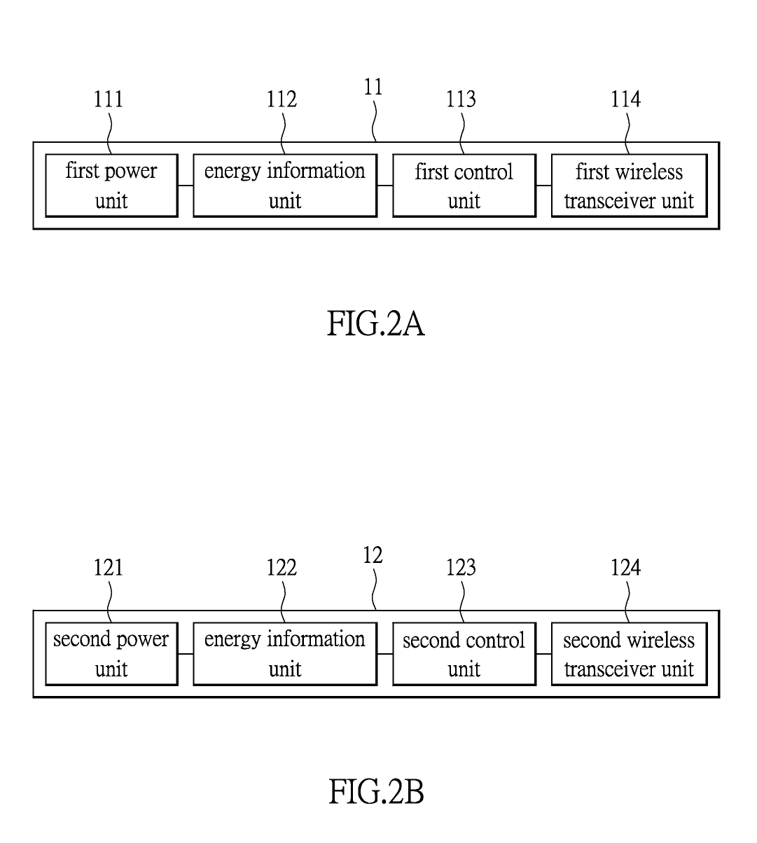

In one embodiment, the power module 12 may be an electronic device. For example, the power module 12 may be a mobile device used as a management platform, such as a smart phone, a tablet PC or a notebook. Please refer to FIG. 2A and FIG. 2B. FIG. 2A shows a block diagram of a power module in the system of wireless power transmission according to an embodiment of the instant disclosure. FIG. 2B shows a block diagram of a power module in the system of wireless power transmission according to an embodiment of the instant disclosure.

The power module 12 comprises a second power unit 121, an energy information unit 122, a second control unit 123 and a second wireless transceiver unit 124. The second power unit 12 has a second electric energy. The energy information unit 122 is coupled to the second power unit 121, for generating a second power transmission information. The first power transmission information comprises at least one of the first electric energy, the distance of power transmission, an address of the communication protocol and a corresponding name of the first power module 12. The second control unit 123 is coupled to the second energy information unit 122. The second wireless transceiver unit 124 is coupled to the second control unit 123. The second wireless transceiver unit 124 has at least a second wireless transmission terminal, for making the second wireless transceiver unit 124 and the first wireless transceiver unit 114 send/receive the first power transmission information and the second power transmission information to each other. The second control unit 123 generates a control signal according to first power transmission information and the second power transmission information. The control signal is sent to the power module 11 through the second wireless transceiver unit 124. The control signal is used to set the second control unit 123 and the first control unit 113 to be a master control unit and a slave control unit respectively. The first control unit 113 of the power module 11 determines whether the power module 11 sends/receives electrical energy according to the control signal. In one embodiment, the power modules 11 determine the priority for the power module according to the control signal, in which the determined priority comprises the priority of wireless sending/receiving electrical energy.

In one embodiment, the first wireless transceiver unit 114 has two first wireless transmission terminals. Each of the two first wireless transmission terminals is in charge of different function. One of the first wireless transmission terminals is used to transmit the first power transmission information and the second power transmission information to the second wireless transceiver unit 124, and vice versa. Another of the first wireless transmission terminal is used to transmit electrical energy to the second wireless transceiver unit 124, and vice versa. Thus, the first wireless transceiver unit 114 sends/receives first power transmission information, the second power transmission information and electrical energy. The instant disclosure does not limit the number of the first wireless transmission terminals. The second wireless transceiver unit 124 operates in similar manner as the first wireless transceiver unit 114, thus the redundant information is not repeated.

In one embodiment, the first wireless transceiver unit 114 has only one first wireless transmission terminal for transmitting the first power transmission information, the second power transmission information and electrical energy to the second wireless transceiver unit 124, and vice versa. Thus, the first wireless transceiver unit 114 sends/receives the first power transmission information, the second power transmission information and electrical energy. The second wireless transceiver unit 124 operates in similar manner as the first wireless transceiver unit 114, thus the redundant information is not repeated.

Please refer to FIG. 1 in conjunction with FIG. 2A and FIG. 2B. The second control unit 123 of the power module 12 generates the control signal according to the first power transmission information and the second power transmission information. The control signal is transmitted to the power modules 11 through the second wireless transmission terminal 124. The second control unit 123 is used for selecting the second control unit 123 to be a master control unit 12a. The first control units 113 in the power modules 11 are defined as slave control units 11a. The second control unit 123 (which is the master control unit 12a) determines to send the second power transmission information and the electrical energy to the power modules 11 or one specific power module 11 (or some power modules 11). The second control unit 123 also controls the first control unit(s) 113 (which is the slave control unit 11a) to determine for receiving the first power information and the electrical energy from the power modules 11 (or some specific power modules 11). Further, the second control unit 123 could control the first control unit 113 of a specific power module 11 to decide to send the first power information and the electrical energy to a designated power module 11. More specifically, the second control unit 123 of the power module 12 controls the second wireless transceiver unit 124 to receive the first power transmission information from the first wireless transceiver unit 114 of the power module 11, in order to determine which power modules are in low energy state. The second control unit 123 could generate a control signal according to the first power information and the second power information. The control signal is sent to the first control unit 113 of the power module 11 through the second wireless transceiver unit 124, thus the first control unit 113 could determine whether to send or receive electrical energy accordingly. In other words, the second control unit 123 generates the control signal so as to make some designated power modules 11 (or one designated power module 11) to supply electrical energy to the power module 11 in lower energy state. The second control unit 123 also could control the second wireless transceiver unit 124 to wirelessly transmit electrical energy to the first wireless transceiver unit 114, such that the power module 11 in lower energy state could obtain electrical energy. Therefore, the electric energy of the specific (or designated) power module 11 could be adjusted accordingly, and the purpose of consolidation and management of energy balance could be achieved.

### Another Embodiment for a System of Wireless Power Transmission

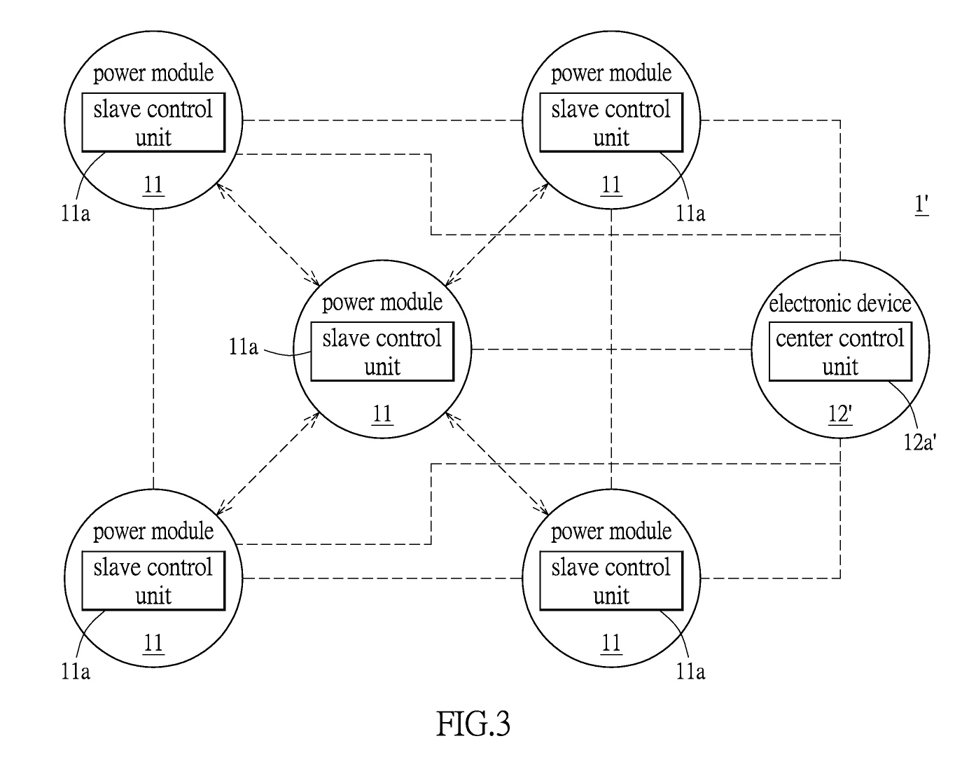

Please refer to FIG. 2B in conjunction with FIG. 3. FIG. 3 shows a schematic diagram of a system of wireless power transmission according to another embodiment of the instant disclosure. The system of wireless power transmission 1′ shown in FIG. 3 is similar to the system of wireless power transmission 1 shown in FIG. 1. The system of wireless power transmission 1′ comprises an electronic device 12′ and a plurality of power modules 11. The electronic device 12′ comprises the second control unit 123 and the second wireless transceiver unit 124 which are possessed of the power module 12 shown in FIG. 2B. The system of wireless power transmission 1′ is significantly identical to the system of wireless power transmission 1 except that the second control unit 123 of the electronic device 12′ is a center control unit 12a′.

In one embodiment, the electronic device 12′ does not comprise the second power unit 121 and the energy information unit 122 which are possessed of the power module 12 shown in FIG. 2B. The second control unit 123 (which is the center control unit 12a′) could receive the first power transmission information from the first wireless transceiver unit 114 of the power module 11 through the second wireless transceiver unit 124. The second control unit 123 also controls the first control unit 113 of a specific power module 11 to send the first power transmission information to a designated power module 11 so as to send the electrical energy to the designated power module 11. More specifically, the center control unit 12a′ of the electronic device 12′ receives the first power transmission information through the second wireless transceiver unit 124 in order to determine which power module 11 is (or power modules 11 are) in lower energy state. The center control unit 12a′ generates a control signal according to the first power transmission information. The control signal is sent to the first control unit 113 of the power module 11 through the second wireless transceiver unit 124, thus the center control unit 12a′ could control the first control unit 113 of any specific power module 11 to transmit electrical energy to the designated power module 11. The center control unit 12a′ itself does not transmit electrical energy to the power module 11 in low energy state. Therefore, the center control unit 12a′ could consolidate and manage the needed electric energy of any power module 11.

In one embodiment, the electronic 12′ comprises the second power unit 121 and the energy information unit 122 which are possessed of the power module 12 shown in FIG. 2B. In this embodiment, the second control unit 123 (which is the center control unit 12a′) of the electronic device 12′ could receive the first power transmission information and electrical energy form the first wireless transceiver unit 114 of the power module 11 through the second wireless transceiver unit 124. The second control unit 123 could also control the first control unit 113 of a specific power module 11 to send the first power transmission information to a designated power module 11 or the electronic device 12′ for determining to send the electrical energy to the designated power module 11 or the electronic device 12′. In the same way, the center control unit 12a′ of the electronic device 12′ receives the first power transmission information through the second wireless transceiver unit 124 for generating a control signal. The control signal is sent to the first control unit 113 of the power module 11 through the second wireless transceiver unit 124. Thus, the center control unit 12a′ could control the first control unit 113 of a specific power module 11 to send the electrical energy to a designated power module 11 or the electronic device 12′, and the center control unit 12a′ could control the first control unit 113 of the designated power module 11 to receive electrical energy. Therefore, not only the power modules 11 could transmit electrical energy to each other directly or indirectly, but also the power modules 11 could transmit electrical energy to each other through the electronic device 12a′. Therefore, the needed electric energy of a designated power module 11 could be consolidated and managed accordingly.

### Another Embodiment for a System of Wireless Power Transmission

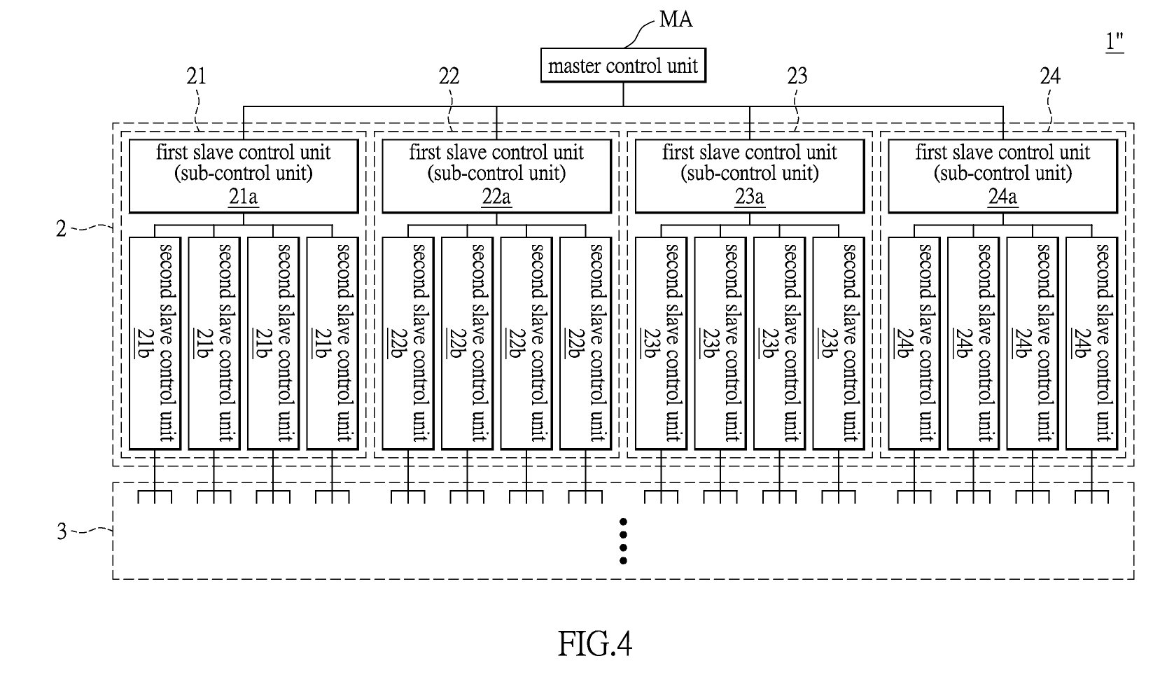

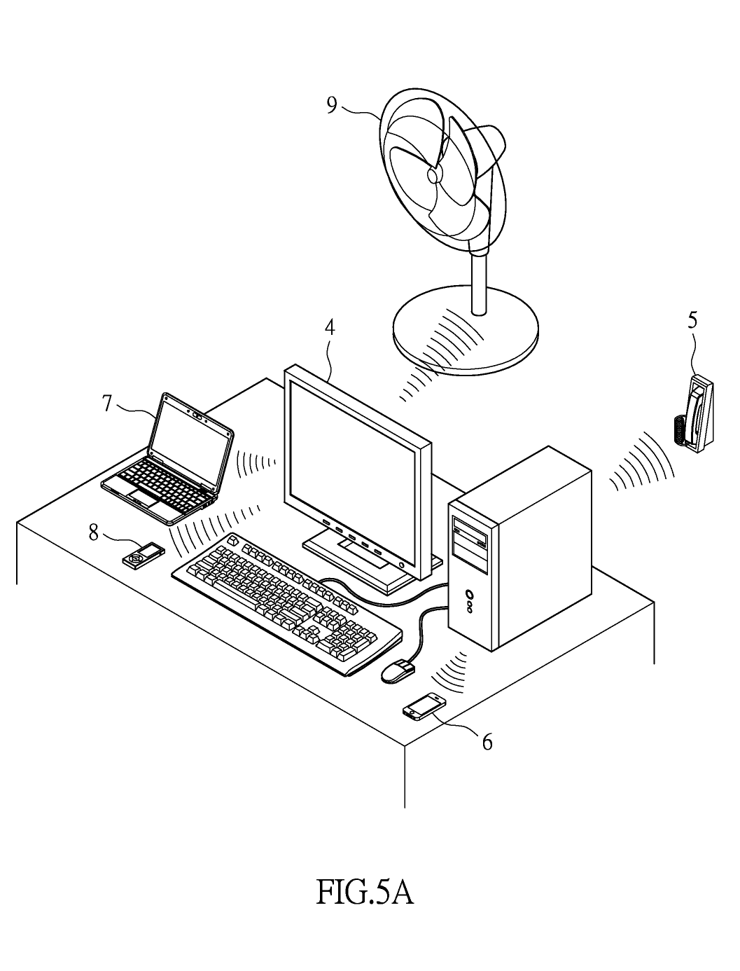

Please refer to FIG. 4 showing a schematic diagram of a system of wireless power transmission according to another embodiment of the instant disclosure. The system of wireless power transmission 1″ comprises a plurality of power modules 11 shown in FIG. 1 (or FIG. 3) and the power module 12a (or 12a′) shown in FIG. 1 (or FIG. 3). The power module 12a (or 12a′) is the master control unit MA. Some power modules 11 are not in the effective transmission range relative to the master control unit MA, such that the master control unit MA could not communicate with or transmit electrical energy to the power modules 11 not in the effective transmission range. First, in order to make the master control unit MA could communicate with the power modules 11 not in the effective transmission range or make the power modules 11 which are in the cluster managed by the master control unit MA but not in the effective transmission range could receive electrical energy. During the control process of the master control unit MA for the slave control units, the master control unit MA receives the first power transmission information through the second wireless transceiver unit 124 to identify a plurality of power modules 11 in the effective transmission range. However, for the unidentified power modules 11 not in the effective transmission range, the first power transmission information of the unidentified power modules 11 near to the identified power modules 11 could be received by the first wireless receiver unit 114 of the identified power modules 11, thus the master control unit MA could indirectly communicate with the unidentified power modules 11 through the identified power modules 11. Therefore, the master control unit MA could control the power modules 11 not in the effective transmission range accordingly.

Then, the plurality of power modules 11 communicate with each other to form a cluster in order to make the master control unit MA control the power modules 11 more efficiently. According to the received first power transmission informations, the master control unit MA could determine the first electric energy possessed of the power modules 11 and the distances of power transmission. The plurality of power modules 11 could divide the cluster into a plurality of groups according to at least one of the first electric energy, the distance of power transmission, an address of the communication protocol and a corresponding name of the first power module. In this embodiment, the way for the group classification of the cluster formed by the plurality of power modules 11 is described in the follows. According to the amounts of the first electric energy (from high energy to low energy) and the distances of power transmission (from near to far), the master control unit MA classifies the power modules 11 into a first class group 2, a second class group 3 . . . and a n-th class group n, wherein “n” is a positive integer. The first class group represents a group having the most electric energy and the shortest distance of power transmission form the master control unit MA. On the contrary, the n-th class group represents a group having the least electric energy and the longest distance of power transmission form the master control unit MA. Additionally, among the plurality of power modules 11, when some power modules 11 is electrically connected to an AC power by wired connections, the first electric energy possessed of the power modules 11 wired connected to the AC power would be determined to be higher than the electric energy possessed of the power modules 11 without connecting to the AC power. In other words, the power modules 11 connecting to the AC power belong to a group having a class higher than the class of the group composed of the power modules 11 without connecting to the AC power.

Furthermore, each of the first class group 2, the second class group 3 . . . and the n-th class group n could be divided into a plurality of sub-groups. Taking the first class group 2 as an example, the first class group 2 has a plurality of power modules 11, the plurality of power modules 11 further divide the cluster (in which the first class group 2 is taken as a cluster) into a plurality of sub-groups according to the amount of the first electric energy held by the power modules 11 or the distance of power transmission. More specifically, among the power modules 11 of the first class group 2, the power modules 11 having similar first electric energy or similar distance of power transmission with each other could be classified into the same sub-group, thus a plurality of sub-groups could be established in the same way. Meanwhile, according to the amounts of the first electric energy (from high energy to low energy) and the distances of power transmission between the sub-groups and the master control unit MA (from near to far), the sub-groups in the first class group 2 could be in the order of a first sub-group 21 of the first class, a second sub-group 22 of the first class, a third sub-group 23 of the first class and a fourth sub-group 24 of the first class. In this embodiment, the power modules 11 in the second class group 3 . . . or the n-th class group are divided into a plurality of sub-groups respectively in the same way.

Additionally, for the first sub-group 21 of the first class, the second sub-group 22 of the first class . . . and the n′-th sub-group of the n-th class (in which n′ and n may not the same integer), the control signal generated by the master control unit MA is for selecting one of the first control units of the power modules in the first sub-group 21 of the first class, the second sub-group 22 of the first class . . . and the n′-th sub-group of the n-th class to be a sub-control unit. For example, a sub-control unit 21a (i.e. the first slave control unit) in the first sub-group 21 of the first class is determined according to the control signal, and else first control units are defined as second slave control units 21b. A sub-control unit 22a (i.e. the first slave control unit) in the second sub-group 22 of the first class is determined according to the control signal, and else first control units are defined as second slave control units 22b. A sub-control unit 23a (i.e. the first slave control unit) in the third sub-group 23 of the first class is determined according to the control signal, and else first control units are defined as second slave control units 23b. A sub-control unit 24a i.e. the first slave control unit) in the fourth sub-group 24 of the first class is determined according to the control signal, and else first control units are defined as second slave control units 24b. The sub-control units 21a, 22a, 23a, 24a . . . set by the master control unit MA manage the first power modules in the first sub-group 21 of the first class, the second sub-group 22 of the first class . . . and the n′-th sub-group of the n-th class to send/receive electrical energy. It is worth mentioning that when the master control unit MA cannot operate normally due to that the power module having the master control unit MA is damaged or out of energy, the sub-control unit 21a of the first sub-group 21 of the first class would substitute for the master control unit MA to be the new master control unit (MA). In other words, the sub-control unit 21a has the priority second to the original master control unit MA. After this, the master control unit MA is replaced sequentially in the order of the second sub-group 22 of the first class, the third sub-group 23 of the first class . . . and the n′-th sub-group of the n-th class when the event of abnormally operation for the master control unit MA happens again. Excepting the aforementioned classification manner, addresses of the communication protocol and corresponding names of the power modules could be used to classify the plurality of power modules. Each first wireless transceiver unit of the plurality of power module shown in FIG. 4 has a designated address of the communication protocol, thus the plurality of power modules could communication to each other. The master control unit MA could communicate with the power modules in the effective transmission range. The master control unit MA could also indirectly control power modules 11 not in the effective transmission range through the power modules 11 in the effective transmission range. During the process of dividing the plurality of power modules 11 into a plurality of groups, the master control unit MA could obtain the information about the addresses of the communication protocol according to the first power transmission information transmitted by the first wireless transceiver units 114 of the power modules 11. According to the addresses of the communication protocol, the master-slave relationship between the electronic device (12′) and the power modules 11 could be defined by the user, thus the master control unit and the slave control units is defined by the user. Alternatively, the user could arrange some specific power modules 11 of the plurality of power modules 11 into the first class group, the second class group or other classified groups. The user could also define one power module 11 in each group to be the sub-control unit. However, the first power transmission information transmitted by the first wireless transceiver unit 114 may also comprise information about a corresponding name of the power modules 11. Thus the user may divide the power modules 11 into groups according to the corresponding names of the power modules 11.

In another embodiment, as shown in FIG. 1, when the power module 12 is the power module 11 in the system of wireless power transmission 1, the system of wireless power transmission only comprises the aforementioned power modules 11. Different from previous embodiments, the control signal in this embodiment is not only generated according to the first power transmission information and the second power transmission information but also be a randomly generated control signal for the power module 11 to receive. In this embodiment, the control signal is used for randomly selecting one of the first control units of the power modules 11 to be the master control unit, else first control units are defined as slave control units. More specifically, the master control unit may not classify the power modules 11 according to related information about the power modules, such as the electric energy, the distance of power transmission, the address of the communication protocol and the corresponding name of each power module. The master control unit may classify the power modules 11 randomly. As described in previous embodiments, the first control unit of one of the power modules in each group is a sub-control unit. Similarly, the operation of the sub-control units and the master control unit in accordance with the present embodiment is similar to that of previous embodiments, thus the redundant information is not repeated.

It is worth mentioning that, in one embodiment, the plurality of power modules 11 could not only form a single cluster, thus some power modules of the plurality of power modules 11 could be the first power modules, and else power modules could be the second power modules. Meanwhile, the first power modules form a first cluster, and the second power modules form a second cluster. The first cluster and the second cluster determine the priority for each other and send/receive electrical energy to each other. The operation of power transmission between the first power modules in the first cluster and the second power modules in the second cluster in accordance with the present embodiment is similar to that of previous embodiments, thus the redundant information is not repeated.

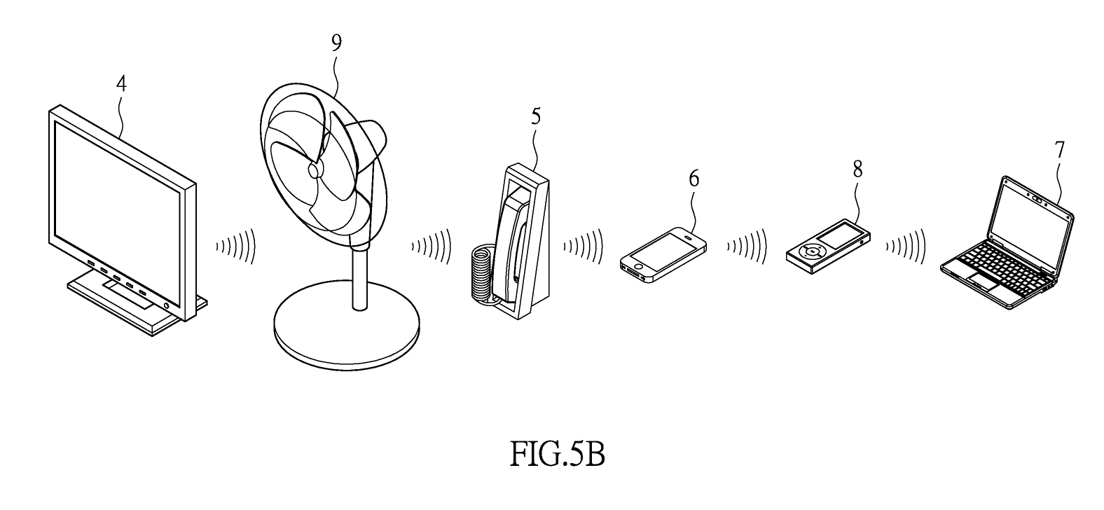

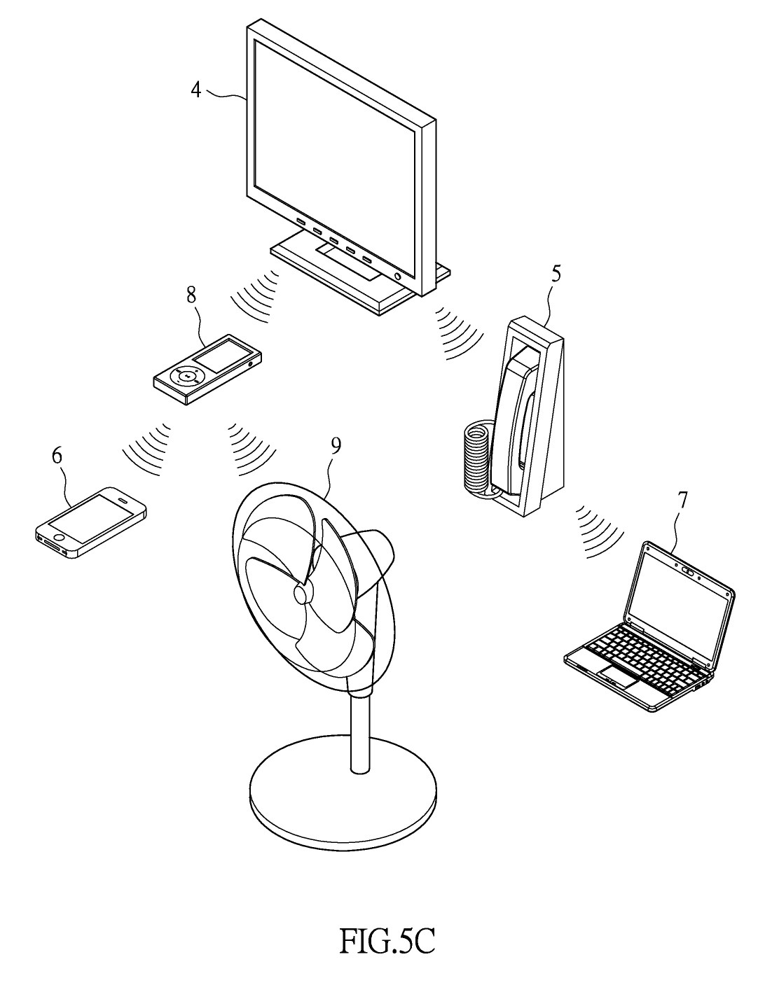

The instant disclosure does not limit the arrangement of the power modules 11 and the power module 12. The arrangement of the power modules 11 and the power module 12 could be placed in any order. For example, the topology of the system could be a star topology, a linear topology or a tree topology. Referring to FIG. 5A in conjunction with FIG. 5B and FIG. 5C. FIG. 5A shows a schematic diagram of a system of wireless power transmission arranged in a star topology according to another embodiment of the instant disclosure. FIG. 5B shows a schematic diagram of a system of wireless power transmission arranged in a linear topology according to another embodiment of the instant disclosure. FIG. 5C shows a schematic diagram of a system of wireless power transmission arranged in a tree topology according to another embodiment of the instant disclosure. A desktop 4 could be taken as the master control unit 12a or the center control unit 12a′ in the system of this embodiment. A wall-mounted telephone 5, a smart phone 6, a notebook 7, a video player 8 and a stand fan 9 could be taken as the power modules 11. The star topology is shown in FIG. 5A, and the desktop 4 is the center of the system of wireless power transmission. When the desktop 4 is the master control unit 12a, the desktop 4 could directly and wirelessly transmit the first power transmission information, the second power transmission information and electrical energy to the wall-mounted telephone 5, the smart phone 6, the notebook 7, the video player 8 and the stand fan 9. Similarly, when the desktop 4 is the center control unit 12a′, the desktop 4 could directly and wirelessly transmit the first power transmission information and electrical energy to the wall-mounted telephone 5, the smart phone 6, the notebook 7, the video player 8 and the stand fan 9. The linear topology is shown in FIG. 5B. The desktop 4 could wirelessly transmit the first power transmission information, the second power transmission information and electrical energy to the stand fan 9, and could wirelessly transmit the first power transmission information, the second power transmission information and electrical energy to the wall-mounted telephone 5 through the stand fan 9. The transmission manner of the first power transmission information, the second power transmission information and electrical energy for the wall-mounted telephone 5, the smart phone 6, the notebook 7 and the video player 8 is similar. In the same way, when the desktop 4 is the center control unit 12a′, the desktop 4 could wirelessly transmit the first power transmission information and electrical energy to the stand fan 9, and could wirelessly transmit the first power transmission information and electrical energy to the wall-mounted telephone 5 through the stand fan 9. The transmission manner of the first power transmission information and electrical energy for the wall-mounted telephone 5, the smart phone 6, the notebook 7 and the video player 8 is similar. The tree topology is shown in FIG. 5C. When the desktop 4 is the master control unit 12a, the desktop 4 could wirelessly transmit the first power transmission information, the second power transmission information and electrical energy to the video player 8 or the wall-mounted telephone 5. Then, the video player 8 wirelessly transmits the first power transmission information, the second power transmission information and electrical energy to the smart phone 6 and the stand fan 9. And, the first power transmission information, the second power transmission information and electrical energy could be wirelessly transmitted to the notebook 7 through the wall-mounted telephone 5. In the same way, when the desktop 4 is the center control unit 12a′, the desktop 4 could wirelessly transmit the first power transmission information and electrical energy to the video player 8 or the wall-mounted telephone 5. Then, the video player 8 wirelessly transmits the first power transmission information and electrical energy to the smart phone 6 and the stand fan 9. And, the first power transmission information and electrical energy could be wirelessly transmitted to the notebook 7 through the wall-mounted telephone 5. However, this embodiment does not limit the arrangement of the electronic device and the power modules.

### An Embodiment for a Method of Wireless Power Transmission

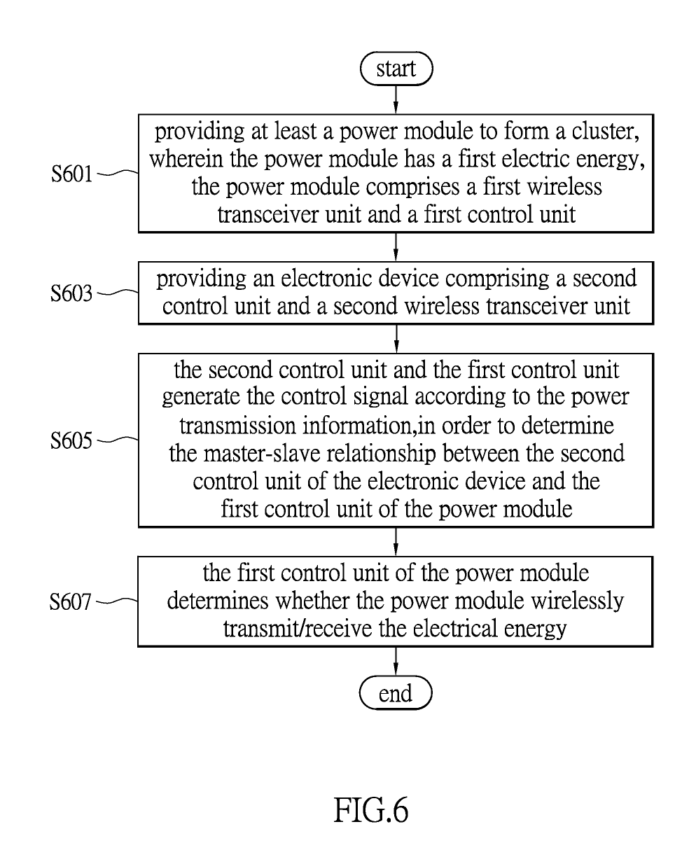

Please refer to FIG. 2A in conjunction with FIG. 2B and FIG. 6. FIG. 6 shows a flow chart of a method of wireless power transmission according to an embodiment of the instant disclosure. As shown in FIG. 6, the method of wireless power transmission comprises steps as follows. Providing at least a power module 11 to form a cluster, wherein the power module 11 has a first electric energy, the power module 11 comprises a first wireless transceiver unit 114 and a first control unit (S601). This embodiment does not limit the classification manner for the power modules 11. That is, the power modules 11 could be arranged to the first power modules, the second power modules . . . and the n-th power modules (not shown in the figure) in order to form a first cluster, a second cluster . . . and a n-th cluster. In practical applications, the wireless transceiver unit 114 wireless transmits the first power transmission information and the electrical energy. The first control unit 113 of the power module 11 controls the first wireless transceiver unit 114 to send/receive the first power transmission information and electrical energy. The first power transmission information comprises at least one of the first electric energy, the distance of power transmission, an address of the communication protocol and a corresponding name of the first power module. Then, providing a power module 12 (which could be an electronic device) comprising a second control unit and a second wireless transceiver unit (S603). In practical applications, the second wireless transceiver unit 124 and the first wireless transceiver unit 114 transmit the first power transmission information and electrical energy to each other. The second control unit 123 and the first control unit 113 generate a control signal according to the first transmission information in order to determine the master-slave relationship between the second control unit 123 of the power module 12 and the first control unit 113 of the power module 11 (S605). In practical application, the control signal is transmitted to the power module 11 through the second wireless transceiver unit 124, and the control signal is used for determining the second control unit 123 and the first control unit 113 to be a master control unit and a slave control unit respectively. Then, the first control unit 113 of the power module 11 determines whether the power module 11 wirelessly transmit/receive the electrical energy according to the control signal (S607). In practical applications, the second control unit 123 could obtain the status of what power module 11 is in low energy state and sends the control signal to the power module 11 in low energy state for controlling the first control unit 113 of the power module 11 in low energy state to receive electrical energy according to the control signal.

In one embodiment, in step S603, the power module 12 further comprises a second electric energy. The second wireless transceiver unit 124 wirelessly sends/receives the second power transmission information. The second wireless transceiver unit 124 and the first wireless transceiver unit 114 transmit the first power transmission information, the second power transmission information and the electrical energy. The second power transmission information comprises at least one of the second electric energy, the distance of power transmission, an address of the communication protocol and a corresponding name of the first power module. Further, in step S605, the second control unit 123 and the first control unit 113 generate the control signal not only according to the first power transmission information but also according to the second power transmission information, in order to define the master-slave relationship between the second control unit 123 of the power module 12 and the first control unit 113 of the power module 11.

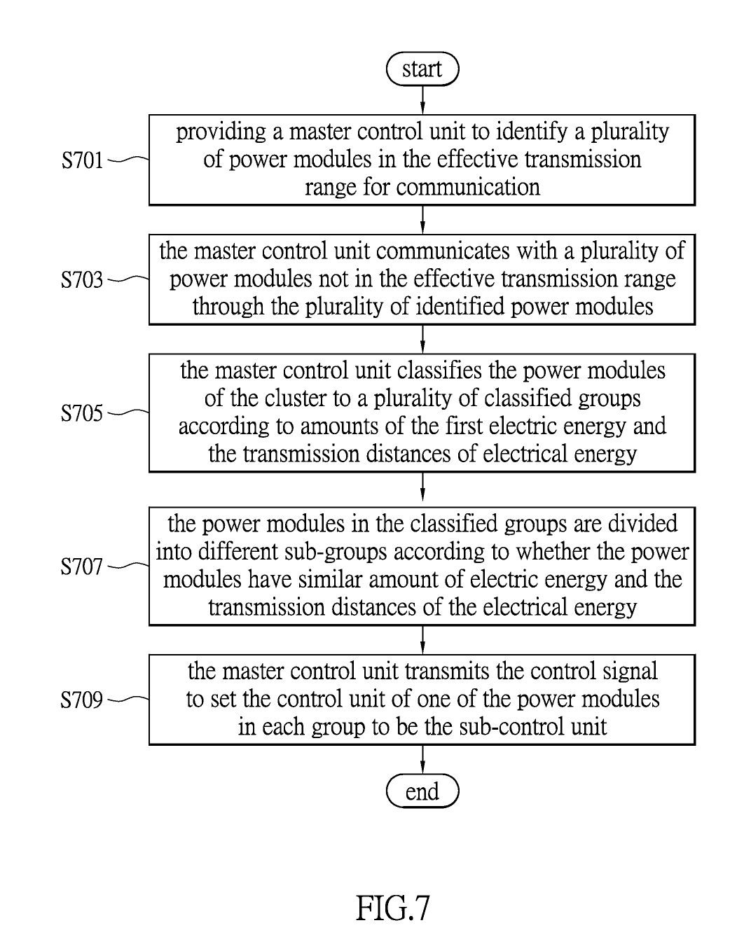

Please refer to FIG. 2A, FIG. 2B, FIG. 4 and FIG. 7. FIG. 7 shows a flow chart of a method of wireless power transmission according to another embodiment of the instant disclosure. As shown in FIG. 7, the method of wireless power transmission comprises steps as follows. First, providing a master control unit MA to identify a plurality of power modules in the effective transmission range for communication (S701). Then, the master control unit MA communicates with a plurality of power modules 11 not in the effective transmission range through the plurality of identified power modules 11 (703). In practical applications, the master control unit MA controls the wireless transceiver units 114 of the identified power modules 11 to receive the power transmission information of neighboring unidentified power modules 11. And, the first wireless transceiver units 114 of the identified power modules 11 are utilized to send the power transmission information of the unidentified power modules 11 to the master control unit MA. Thus, the master control unit MA could indirectly communicate with the unidentified power modules 11 through the identified power modules 11 to form a first cluster, and the power modules 11 not in the effective transmission range could be controlled accordingly. Then, the master control unit MA classifies the power modules of the (first) cluster to a plurality of classified groups according to amounts of the first electric energy and the transmission distances of electrical energy (S705). In practical applications, according to the amounts of the first electric energy (from high energy to low energy) and the distances of power transmission (from near to far), the master control unit MA classifies the power modules 11 into a first class group 2, a second class group 3 . . . and a n-th class group n, wherein the n is a positive integer. When some power modules 11 (among the plurality of the power module 11) are electrically coupled to the AC power by wired connections, the first electric energy possessed of the power modules 11 wired connected to the AC power would be determined to higher than the electric energy possessed of the power modules 11 without connecting to the AC power. Then, the power modules 11 in the classified groups are divided into different sub-groups according to whether the power modules 11 have similar amount of electric energy and the transmission distances of the electrical energy (S707). In practical applications, the first class group 2, the second class group 3 . . . and the n-th class group n could be divided into a plurality of sub-groups. Taking the first class group 2 as an example, the first class group 2 has a plurality of power modules 11. Among the power modules 11 of the first class group 2, the power modules 11 having similar first electric energy or similar distance of power transmission with each other could be classified in the same sub-group, thus a plurality of sub-groups could be established in the same way. Meanwhile, according to the amounts of the first electric energy (from high energy to low energy) and the distances of power transmission between the sub-groups and the master control unit MA (from near to far), the sub-groups in the first class group 2 could be in the order of a first sub-group 21 of the first class, a second sub-group 22 of the first class, a third sub-group 23 of the first class and a fourth sub-group 24 of the first class. In this embodiment, the power modules 11 in the second class group 3 . . . or the n-th class group are divided into a plurality of sub-groups in the same way. Then, the master control unit MA transmits the control signal to set the control unit of one of the power modules in each group (comprising the first group 21 of the first class . . . the n′-th group of the n-th class) to be the sub-control unit (S709). In practical applications, the sub-control units set by the master control unit MA manage the first power modules in the first sub-group 21 of the first class, the second sub-group 22 of the first class . . . and the n′-th sub-group of the n-th class to send/receive electrical energy. When the master control unit MA cannot operate normally due to that the power module having the master control unit MA is damaged or out of energy, the master control unit MA is replaced sequentially in the order of the sub-control unit of the second sub-group 22 of the first class, the sub-control unit of the third sub-group 23 of the first class . . . and the sub-control unit of the n′-th sub-group of the n-th class.

Excepting the aforementioned classification manner, the master control unit MA could receive the power transmission information of each power module 11 through the first wireless transceiver unit 114 of the power module 11. The power transmission information not only comprises the first energy and the distance of power transmission, but also comprises the addresses of the communication protocol and corresponding names of the power modules. Referring to the addresses of the communication protocol and corresponding names of the power modules, the user could define the master-slave relationship between the electronic device and the plurality of power modules 11 according to personal preferences, thus the master control unit and the slave control units could be defined by the user. Alternatively, the user could arrange some specific power modules 11 of the plurality of power modules 11 into the first class group, the second class group or other classified groups. The user could also define one power module 11 in each group to be the sub-control unit.

In one embodiment, a method of wireless power transmission may comprise providing a plurality of first power modules to from a first cluster, the first power module having a first electric energy, the first power module comprising a first wireless transceiver unit and a first control unit, the first wireless transceiver unit wireless sending/receiving a first power transmission information and electrical energy, the first control unit of the first power module controlling the first wireless transceiver unit to send/receive the first power transmission information and electrical energy, wherein the first power transmission information comprises at least one of the first electric energy, the distance of power transmission, an address of the communication protocol and a corresponding name of the first power module; wherein the plurality of power modules determines the priority of wireless sending/receiving electrical energy according to a control signal. In this embodiment, the control signal is used for randomly selecting one of the first control units of the power modules 11 to be the master control unit, else first control units are defined as slave control units. The master control unit may not classify the power modules 11 according to related information about the power modules, such as the first electric energy, the distance of power transmission, the address of the communication protocol and the corresponding name of each power module. The master control unit may classify the power modules 11 randomly. As described in previous embodiments, the first control unit of one of the power modules in each group is a sub-control unit. Similarly, the operation of the sub-control units and the master control unit in accordance with the present embodiment is similar to that of previous embodiments, thus the redundant information is not repeated.

It is worth mentioning that, in one embodiment, the plurality of power modules 11 could not only form a single cluster, thus some power modules of the plurality of power modules 11 could be the first power modules, and else power modules could be the second power modules. Meanwhile, the first power modules form a first cluster, and the second power modules form a second cluster. The first cluster and the second cluster send/receive electrical energy to each other. The operation of power transmission between the first power modules in the first cluster and the second power modules in the second cluster in accordance with the present embodiment is similar to that of previous embodiments, thus the redundant information is not repeated.

According to above descriptions, the system and method of wireless power transmission determine whether the plurality of power modules transmit electrical energy to each other, and determine the electrical energy should be transmitted to which one power module or which power modules. The system and method of wireless power transmission could determine whether the power module receives the electrical energy, and even determine the power module receive electrical energy from which one power module or which power modules.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A system of wireless power transmission, comprising:
a plurality of first power modules, forming a first cluster, each first power module comprising:
a first power unit, having a first electric energy;
an energy information unit, coupled to the first power unit, generating a first power transmission information, wherein the first power transmission information comprises at least one of the first electric energy, the distance of power transmission, an address of the communication protocol and a corresponding name of the first power module;
a first wireless transceiver unit, having at least a first wireless transmission terminal, the wireless transceiver unit sending/receiving the first power transmission information and electrical energy through the first wireless transmission terminal; and
a first control unit, coupled to the energy information unit and the first wireless transceiver unit, controlling the first wireless transceiver unit to send/receive the first power transmission information and electrical energy;
wherein the first wireless transceiver units of the plurality of first power modules send the first power transmission information to each other, the first power modules determine the priority for each other according to a control signal.

2. The system of wireless power transmission according to claim 1, wherein the control signal is used for selecting one of the first control units to be a master control unit, else first control units are defined as slave control units, the slave control units are divided into a plurality of groups, wherein the master control unit manages the slave control units to send/receive electrical energy.

3. The system of wireless power transmission according to claim 1, wherein the first control unit generates the control signal according to the first power transmission information, the control signal is used for selecting one of the first control units of the plurality of first power modules to be a master control unit, else first control units are defined as slave control units, wherein the master control unit manages the slave control units to send/receive electrical energy.

4. The system of wireless power transmission according to claim 3, wherein the plurality of power modules are divided into a plurality of groups according to the respective first power transmission information held by each of the power modules.

5. The system of wireless power transmission according to claim 2, wherein one of the first control units of the power modules in each group is a sub-control unit, the sub-control unit manages the plurality of first power modules in the corresponding group to send/receive electrical energy.

6. The system of wireless power transmission according to claim 4, wherein one of the first control units of the first power modules is a sub-control unit, the sub-control unit manages the plurality of first power modules in the corresponding group to send/receive electrical energy.

7. The system of wireless power transmission according to claim 5, wherein one of the sub-control units in the groups is substituted for the master control unit when the master control unit is not operating normally.

8. The system of wireless power transmission according to claim 6, wherein one of the sub-control units in the groups is substituted for the master control unit when the master control unit is not operating normally.

9. The system of wireless power transmission according to claim 7, wherein the sub-control unit substituted for the master control unit has the priority second only to the master control unit.

10. The system of wireless power transmission according to claim 8, wherein the sub-control unit substituted for the master control unit has the priority second only to the master control unit.

11. The system of wireless power transmission according to claim 2, wherein the master-slave relationship between the master control unit and the slave control units is defined by the user.

12. The system of wireless power transmission according to claim 3, wherein the master-slave relationship between the master control unit and the slave control units is defined by the user.

13. The system of wireless power transmission according to claim 1, further comprising a second cluster, the second cluster comprising a plurality of second power modules, wherein the first power modules of the first cluster and the second power modules of the second cluster determine the priority for each other and send/receive electrical energy to each other.

14. The system of wireless power transmission according to claim 1, wherein the determined priority comprises the priority of wireless sending/receiving electrical energy.

15. A system of wireless power transmission, comprising:
at least a first power module, forming a first cluster, the first power module comprising:
a first power unit, having a first electric energy;
a first energy information unit, coupled to the first power unit, generating a first power transmission information;
a first wireless transceiver unit, having at least a first wireless transmission terminal, the wireless transceiver unit sending/receiving the first power transmission information and electrical energy through the first wireless transmission terminal; and
a first control unit, coupled to the first energy information unit and the first wireless transceiver unit, controlling the first wireless transceiver unit to send/receive the first power transmission information and electrical energy, wherein the first power transmission information comprises at least one of the first electric energy, the distance of power transmission, an address of the communication protocol and a corresponding name of the first power module; and
a second power module, comprising:
a second power unit, have a second electric energy;
a second energy information unit, coupled to the second power unit, generating a second power transmission information, wherein the second power transmission information comprises at least one of the second electric energy, the distance of power transmission, an address of the communication protocol and a corresponding name of the second power module;
a second control unit, coupled to the second energy information unit; and
a second wireless transceiver unit, coupled to the second control unit, having at least a second wireless transmission terminal, the second wireless transceiver unit and the first wireless transceiver unit sending/receiving the first power transmission information and the second power transmission information to each other;
wherein the second wireless transceiver unit generates a control signal according to first power transmission information and the second power transmission information, the control signal is sent to the first power module through the second wireless transceiver unit, wherein the first control unit of the first power module determines the priority for the first power module according to the control signal.

16. The system of wireless power transmission according to claim 15, wherein the first power module and the second power module transmit electrical energy to each other through the first wireless transceiver unit and the second transceiver unit.

17. The system of wireless power transmission according to claim 16, wherein the second control unit determines the second control unit of the second power module and the first control unit of the first power module to be a master control unit and a slave control unit respectively according to the first power transmission information and the second power transmission information.

18. The system of wireless power transmission according to claim 17, wherein the system comprises a plurality of first power modules, the master control unit manages the slave control units to send/receive electrical energy, the master control unit divides the plurality of first power modules into a plurality of groups according to the first power transmission information.

19. The system of wireless power transmission according to claim 18, wherein one of the first control units of the first power modules in each group is a sub-control unit, the sub-control unit manage the first power modules in the corresponding group to send/receive electrical energy, wherein one of the sub-control units is substituted for the master control unit when the master control unit is not operating normally.

20. The system of wireless power transmission according to claim 15, further comprising a second cluster, the second cluster comprising at least one second power module, wherein the first power module of the first cluster and the second power module of the second cluster send/receive electrical energy to each other.

21. The system of wireless power transmission according to claim 15, wherein the determined priority comprises the priority of wireless sending/receiving electrical energy.

22. A method of wireless power transmission, comprising:
providing a plurality of first power modules to from a first cluster, the first power module having a first electric energy, the first power module comprising a first wireless transceiver unit and a first control unit, the first wireless transceiver unit wireless sending/receiving a first power transmission information and electrical energy, the first control unit of the first power module controlling the first wireless transceiver unit to send/receive the first power transmission information and electrical energy, wherein the first power transmission information comprises at least one of the first electric energy, the distance of power transmission, an address of the communication protocol and a corresponding name of the first power module;
wherein the plurality of power modules determines the priority of wireless sending/receiving electrical energy according to a control signal.

23. The method of wireless power transmission according to claim 22, wherein the plurality of first control units generates the control signal according to the first power transmission information, the control signal is for determining one of the first control units to be a master control unit, else first control units are slave control units, wherein the master control unit manages the slave control units to send/receive electrical energy.

24. The method of wireless power transmission according to claim 22, wherein the control signal is used for selecting one of the first control units to be a master control unit, else first control units are defined as slave control units, the slave control units are divided into a plurality of groups, wherein the master control unit manages the slave control units to send/receive electrical energy.

25. The method of wireless power transmission according to claim 23, wherein one of the first control units of the first power modules in each group is a sub-control unit, the sub-control unit manages the plurality of first power modules in the corresponding group to send/receive electrical energy, wherein one of the sub-control units is substituted for the master control unit when the master control unit is not operating normally.

26. The method of wireless power transmission according to claim 24, wherein one of the first control units of the power modules in each group is a sub-control unit, the sub-control unit manages the plurality of first power modules in the corresponding group to send/receive electrical energy, wherein one of the sub-control units is substituted for the master control unit when the master control unit is not operating normally.

27. The method of wireless power transmission according to claim 22, further comprising a second cluster, the second cluster comprising at one second power module, wherein the first power module of the first cluster and the second power module of the second cluster send/receive electrical energy to each other.

28. The method of wireless power transmission according to claim 22,
providing an electronic device, the electronic device comprising a second control unit and a second wireless transceiver unit, wherein the second wireless transceiver unit and the first wireless transceiver unit transmit the first power transmission information; and
the second control unit generating the control signal according to the first power transmission information, wherein the control signal is sent to the first power module through the second wireless transceiver unit, wherein the control signal is for determining the second control unit and the first control unit to be the master control unit and the slave control unit respectively.
